(19) United States
(12) Patent Application Publication
(10) Pub. No.: US 2004/0160302 A1
(43) Pub. Date: Aug. 19, 2004

(54) Actuator and switch

(76) Inventors: Masazumi Yasuoka, Tokyo (JP); Hirokazu Sanpei, Tokyo (JP); Jun Mizuno, Tokyo (JP)

Correspondence Address: ROSENTHAL & OSHA L.L.P., Suite 2800, 1221 McKinney, Houston, TX, 77010, US

(21) Appl. No.: 10/781,444

(22) Filed: Feb. 18, 2004

Related U.S. Application Data
(63) Continuation of application No. PCT/JP02/06748, filed on Jul. 3, 2002.

(30) Foreign Application Priority Data
Aug. 21, 2001 (JP) 2001-250915

(51) Int. Cl. H01H 37/52

(52) U.S. Cl. 337/333; 337/379

(57) ABSTRACT

A switch, comprising a movable part supported at both ends and a contact installed on the movable part, the movable part characterized by further comprising a first bimetal for displacing the contact in a specified direction according to a temperature and a second bimetal for displacing the contact in the direction opposite to the specified direction according to the temperature.

The present application is a continuation application of PCT/JP02/06748 filed on Jul. 3, 2002, claiming priority from a Japanese patent application No. 2001-250915 filed on Aug. 21, 2001, the contents of which are incorporated herein by reference.

### BACKGROUND OF THE INVENTION

1. Field of the Invention

The present invention relates to an actuator and switch. Conventionally, a switch equipped with a movable part including a bimetal and a heater for heating the bimetal, a contact installed on the movable part, and signal lines facing the contact is known. As for the conventional switch, by supplying current to the heater, the movable part and the contact are displaced and the contact contacts with the plurality of signal lines, so that the continuity between the plurality of signal lines is established.

2. Related Art

In recent years, a switch with low power consumption is desired so that the switch using micro-mechanical technology may be put in practical use. However, as mentioned above, as for the switch using the conventional bimetal structure, contact between the contact and the signal lines has to be maintained while the continuity of the signal lines is maintained. Therefore, while the continuity of the signal lines is being maintained, it needs to supply electric current to the heater of the movable part continuously. Therefore, the electric power consumption of the switch becomes high and this has been a major obstacle to utilization of the switch using micro-mechanical technology.

### SUMMARY OF THE INVENTION

Accordingly, it is an object of the present invention to provide an actuator and switch which can solve the foregoing problem. The object can be achieved by combinations described in the independent claims. The dependent claims define further advantageous and exemplary combinations of the present invention.

In order to solve the foregoing problem, according to a first aspect of the present invention, there is provided a switch including a movable part supported at both ends, and a first contact provided between both the ends of the movable part. The movable part includes: a first bimetal for displacing the contact in a predetermined direction according to temperature; and a second bimetal for displacing the contact in a direction opposite to the predetermined direction according to temperature.

Moreover, it is preferable that the movable part includes a bend in the predetermined direction or the direction opposite to the predetermined direction. Moreover, it is preferable that the first bimetal includes: a first component having a first coefficient of thermal expansion; and a second component deposited on the first component and having a coefficient of thermal expansion lower than the first coefficient of thermal expansion, and the second bimetal includes: a third component having a second coefficient of thermal expansion; and a fourth component deposited on the third component and having a coefficient of thermal expansion higher than the second coefficient of thermal expansion.

Moreover, the first component and the fourth component may be made of the same material, and the second component and the third component may be made of the same material.

Moreover, it is preferable that the switch further includes heaters for heating the first bimetal and the second bimetal, respectively. It is also preferable that the movable part bends in the predetermined direction when the first bimetal is heated, and the movable part bends in the direction opposite to the predetermined direction when the second bimetal is heated. Moreover, it is preferable that both the ends of the movable part are secured.

The movable part may further include: a third bimetal for displacing the contact in the predetermined direction according to temperature; and a fourth bimetal for displacing the contact in the direction opposite to the predetermined direction according to temperature. In this case, it is preferable that the first bimetal, the second bimetal, the third bimetal and the fourth bimetal extend in different directions from a contact position at which the contact is provided.

Moreover, the first bimetal may extend in a direction opposite to a direction in which the third bimetal extends, the second bimetal may extend in a direction substantially perpendicular to the directions in which the first bimetal and the third bimetal extend, and the fourth bimetal may extend in a direction opposite to the direction in which the second bimetal extends.

Moreover, the switch may further include: a first supporting section for supporting one end of the movable part; and a second supporting section for supporting the other end of the movable part, and one end of the first bimetal may be supported by the first supporting section, one end of the second bimetal may be supported by the second supporting section, and another end of the second bimetal extends from the first bimetal, one end of the third bimetal may be supported by the second supporting section and provided substantially parallel with the second bimetal, and one end of the fourth bimetal maybe supported by the first supporting section and another end of the fourth bimetal extends from the third bimetal. In this case, it is preferable that the first bimetal and the third bimetal, and the second bimetal and the fourth bimetal, are estranged from each other.

Moreover, it is preferable that each of the first bimetal and the third bimetal includes: a first component having a first coefficient of thermal expansion; and a second component deposited on the first component and having a coefficient of thermal expansion lower than the first coefficient of thermal expansion, and each of the second bimetal and the fourth bimetal includes: a third component having a second coefficient of thermal expansion; and a fourth component deposited under the third component and having a coefficient of thermal expansion higher than the second coefficient of thermal expansion.

Moreover, it is preferable that the movable part includes a bend in the predetermined direction or in the direction opposite to the predetermined direction. In this case, it is preferable that the switch further includes heaters for heating the first bimetal, the second bimetal, the third bimetal and the fourth bimetal, respectively. It is also preferable that the movable part bends in the predetermined direction when the first bimetal and the third bimetal are heated, and the movable part bends in the direction opposite to the predetermined direction when the second bimetal and the fourth bimetal are heated.

Moreover, it is preferable that the switch further includes a first substrate including a first signal line, a second signal line, and a first supporting section for supporting both the ends of the movable part. It is also preferable that the first contact electrically connects the first signal line and the second signal line by contacting with the first signal line and the second signal line.

Moreover, the switch may further include: a second substrate including a third signal line, a fourth signal line, and a second supporting section for supporting both the ends of the movable part; and a second contact provided on a surface opposite to the surface on which the contact is provided in the movable part, and the second contact may electrically connect the third signal line and the fourth signal line by contacting with the third signal line and the fourth signal line.

The movable part may include an elastic part provided between one end of the movable part and the contact, the elastic part having elasticity in a longitudinal direction of the movable part. In this case, it is preferable that the elastic part has corrugated structure. Moreover, the elastic part may be formed of material expanding and contracting in the longitudinal direction of the movable part.

According to a second aspect of the present invention, there is provided a manufacturing method of a switch including a movable part supported at both ends, and a first contact provided on the movable part. The method includes steps of: preparing a substrate; forming a first component in a first area of the substrate, the first component having a first coefficient of thermal expansion in; forming a second component in a second area of the substrate, the second area including the first area and the second component having a second coefficient of thermal expansion lower than the first coefficient of thermal expansion; and forming a third component in a third area of the substrate, the third area being included in the second area and does not overlap with the first area, and the third component having a coefficient of thermal expansion higher than the second coefficient of thermal expansion.

Moreover, the step of forming the first component may be similar to the step of forming the third component. Moreover, the manufacturing method of a switch may further include a step of removing at least a part of the second component formed between the first area and the third area.

According to a third aspect of the present invention, there is provided an actuator, including: a movable part supported at both ends and including a bend in a predetermined direction; and a drive section for bending the movable part in a direction opposite to the predetermined direction.

According to a fourth aspect of the present invention, there is provided an actuator including a movable part supported at at least one end. The movable part includes: a first bimetal for displacing another end of the movable part in a predetermined direction according to temperature; and a second bimetal for displacing the other end of the movable part in a direction opposite to the predetermined direction according to temperature. It is preferable that the first bimetal and the second bimetal are provided in a direction substantially parallel with a longitudinal direction of the movable part.

This summary of invention does not necessarily describe all necessary features so that the invention may also be a sub-combination of these described features.

### BRIEF DESCRIPTION OF THE DRAWINGS

FIGS. 1A to 1C show a first embodiment of a switch 100, which is an example of an actuator according to the present invention.

FIGS. 2A to 2C are schematic views of movement of the switch 100.

FIGS. 3A and 3B show a second embodiment of the switch 100.

FIG. 4 shows a third embodiment of the switch 100.

FIG. 5 shows a fourth embodiment of the switch 100.

FIGS. 6A to 6C show a fifth embodiment of the switch 100.

FIGS. 7A to 7F show process of manufacturing method of the switch according to an embodiment of the present invention.

FIGS. 8A to 8D show process of the manufacturing method of the switch 100.

FIGS. 9A to 9D show process of the manufacturing method of the switch 100.

FIGS. 10A to 10D show another example of steps of preparing movable part formation substrate explained in FIG. 7A.

### DETAILED DESCRIPTION OF THE INVENTION

The invention will now be described based on the embodiments hereinafter, which do not intend to limit the scope of the present invention as defined in the appended claims. All of the features and the combinations thereof described in the embodiments are not necessarily essential to the invention.

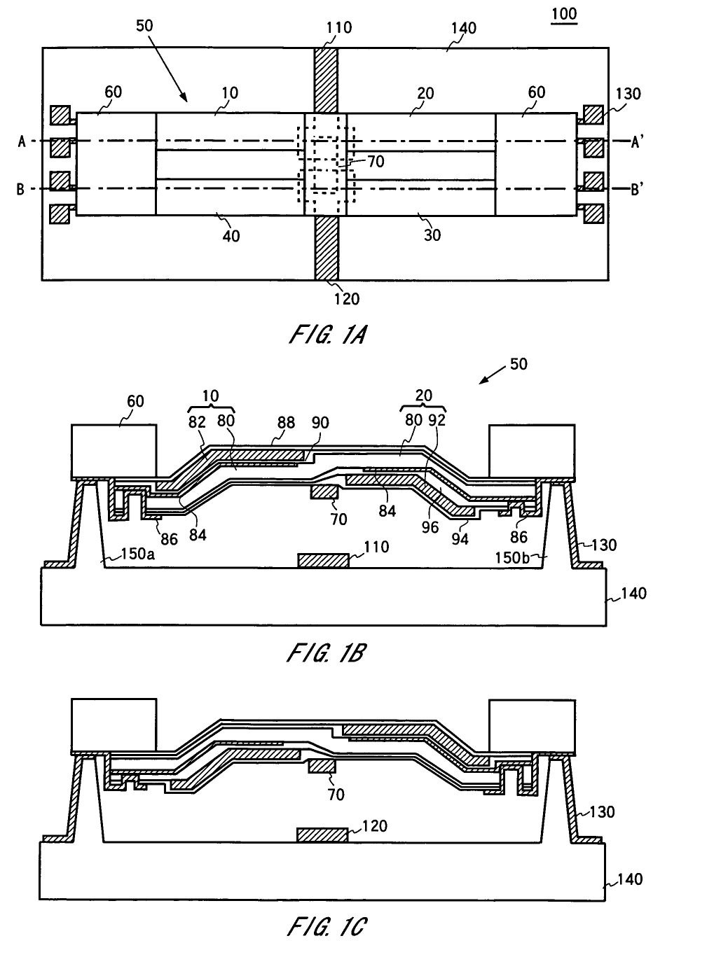

FIGS. 1A to 1C shows a first embodiment of a switch 100, which is an example of an actuator according to the present invention. FIG. 1A is a top view of the switch 100.

The switch 100 includes: a movable part 50; a substrate 140; a first signal line 110 and a second signal line 120 provided on the substrate 140; a plurality of supporting sections 150 provided on the substrate 140 for supporting the movable part 50; a plurality of heater electrodes 130 for supplying electric current to heaters, which are an example of a drive section for driving the movable part 50; supported sections 60 connected to both ends of the movable part 50; and a contact 70 for making the electric connection between the first signal line 110 and the second signal line 120 by contacting with the first signal line 110 and the second signal line 120, the contact 70 being provided on the movable part 50. The movable part 50 includes a first bimetal 10 and a third bimetal 30 for displacing the contact 70 in a predetermined direction according to temperature, and a second bimetal 20 and a fourth bimetal 40 for displacing the contact 70 in a direction opposite to the predetermined direction according to temperature.

It is preferable that the bimetals for displacing the contact 70 in the predetermined direction and the bimetals for displacing the contact 70 in the direction opposite to the predetermined direction are provided substantially parallel with each other. In the present embodiment, the plurality of supporting sections 150 are provided on the substrate 140 and facing each other. One end of the first bimetal 10 is supported by the supporting section 150a through the supported section 60. One end of the second bimetal 20 is supported by the supporting section 150b through the supported section 60, and the other end of the second bimetal 20 extends from the first bimetal 10. That is, the first bimetal 10 and the second bimetal 20 are collinearly arranged between the supporting section 150a and the supporting section 150b.

Moreover, one end of the third bimetal 30 is supported by the supporting section 150b through the supported section 60. One end of the fourth bimetal 40 is supported by the supporting section 150a through the supported section 60, and the other end of the fourth bimetal 40 extends from the third bimeta 130. That is, the third bimetal 30 and the fourth bimetal 40 are collinearly arranged between the supporting section 150a and the supporting section 150b. Moreover, the first bimetal 10, the second bimetal 20, and the third bimetal 30, the fourth bimetal 40, are arranged substantially parallel with each other. Thus, since the bimetals for displacing the contact 70 in different directions are diagonally provided, the displacement of the movable part 50 and the suppress strength of the contact 70 toward the first signal line 110 and the second signal line 120 increase.

It is preferable that the bimetals for displacing the contact 70 in the predetermined direction and the bimetals for displacing the contact 70 in the direction opposite to the predetermined direction are provided so that they are estranged from each other. In the present embodiment, the first bimetal 10 and the second bimetal 20 are estranged from each other, and the third bimetal 30 and the fourth bimetal 40 are estranged from each other. Since the bimetals are thermally insulated by estranging the bimetals for displacing the contact 70 in different directions from each other, the movable part 50 moves with lower electric power consumption.

FIG. 1B is a cross sectional view of the switch 100 taken on line A-A′ in FIG. 1A. Each of the first bimetal 10 and the second bimetal 20 includes a plurality of materials with different coefficients of expansion. In the present embodiment, the first bimetal 10 is constituted by a first component 80 with a predetermined coefficient of thermal expansion, and a second component 82 provided on the first component 80 and has a coefficient of thermal expansion higher than the predetermined coefficient of thermal expansion. Moreover, the second bimetal 20 is constituted by the first component 80 and the third component 92 provided under the first component 80 and has a coefficient of thermal expansion higher than the predetermined coefficient of thermal expansion. Moreover, in the present embodiment, the first component 80 is made of silicon oxide, and the second component 82 and the third component 92 are made of aluminum. In another embodiment, the plurality of materials constituting the first bimetal 10 and the second bimetal 20 may be different from each other. Also in this case, it is preferable that each of them is constituted by a plurality of materials of which the difference of the coefficients of expansion is sufficiently high.

It is preferable that stress in a bimetal for displacing the contact 70 in a predetermined direction at a predetermined temperature, is substantially equal to stress in a bimetal for displacing the contact 70 in a direction opposite to the predetermined direction at the predetermined temperature. Specifically, it is preferable that material, size and thickness of the members constituting the bimetals are made to be equal to one another.

By equalizing the stress in the bimetals at the predetermined temperature, stress in the entire movable part 50 is made into approximately zero. Moreover, since the internal stress generated in the entire movable part 50 becomes approximately zero, even if the ambient temperature around the switch 100 changes, it is maintained at a certain position, without the movable part 50 being displaced.

Moreover, it is preferable that the movable part 50 is arranged so that it has a bend. In this case, it is preferable that the movable part 50 bends substantially symmetrically about the contact 70 between the plurality of supporting sections 150 which support both the ends of the movable part 50. In the present embodiment, the movable part 50 has a bend in a direction away from the substrate 140. Moreover, in the present embodiment, the movable part 50 includes: a first supported end and a second supported end provided at both the ends of the movable part 50 and are supported by the supported section 60; a first inclined part and a second inclined part extending from the first and the second supported ends and inclined to the supported ends; and a central part extending from the first and the second inclined parts and provided between the first and the second inclined parts. Then, the first and the second inclined parts and the central part form the bend.

Since the movable part 50 according to the present embodiment includes a bend, the contact 70 is easily maintained in or out of contact with the first signal line 110 and the second signal line 120 even if the bimetal is not heated.

Moreover, the movable part 50 further includes: heaters 84 for independently heat the bimetals, respectively; protective films 88 and 94 for protecting surfaces of the first component 82 and the second component 92; insulating films 90 and 96 for insulating the first component 82 and the heater 84, and the third component 92 and the heater 84, respectively; and heater lead wires 86 for electrically connecting the heaters 84 and the heater electrodes 130, respectively. It is preferable that each of the heaters 84 is provided between the plurality of components constituting each of the bimetals. By providing the heaters 84 between the components constituting the bimetals, the bimetals can be heated efficiently, and the electric power consumption of the switch 100 is reducible.

In the present embodiment, the heaters 84 are made of platinum and the protective films 88 and 94 and the insulating films 90 and 96 are made of silicon oxide. Moreover, the contact 70 provided on the protective film 94 is made of platinum-chromium alloy.

The heater lead wires 86 are provided over the supported sections 60, and the heater electrodes 130 are provided over the supporting section 150a and the supporting section 150b, respectively. Then, the supporting section 150a and the supporting section 150b fixedly support the supported sections 60 by connecting the heater lead wires 86 provided at the supported sections 60 and the heater electrodes 130 provided on the top of the supporting section 150a and the supporting section 150b. In another embodiment, the supporting section 150a and the supporting section 150b support the supported sections 60 so that the movable part 50 or the supported sections 60 may rotate in a plane substantially perpendicular to the extending direction of the movable part 50.

FIG. 1C is a cross sectional view of the switch 100 taken on line B-B′ in FIG. 1A. The cross section of the switch 100 taken on line B-B′ is a mirror image of the cross section of the switch 100 taken on line A-A′ about the contact 70. In the B-B′ cross section, the contact 70 is provided in the position so that it may contact with the second signal line 120.

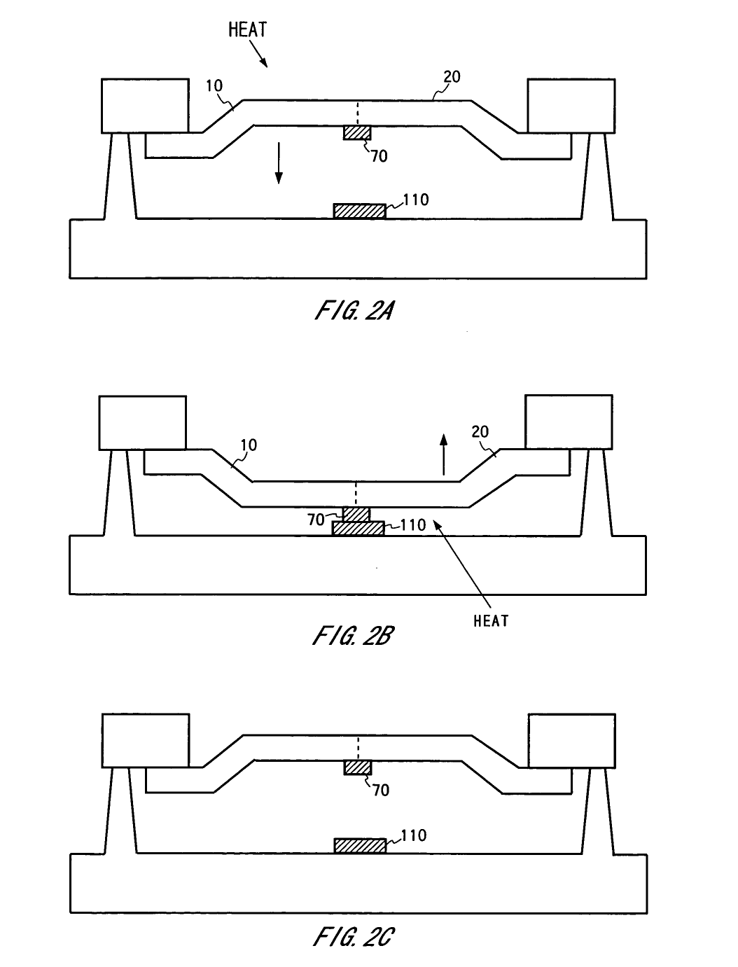

FIGS. 2A to 2C are schematic views of movement of the switch 100. Movement of the switch 100 in the A-A′ cross section explained in reference to FIG. 1A will be exemplary explained. The movable part 50 includes a bend in the direction away from the substrate 140.

First, as shown in FIG. 2A, the first bimetal 10 for displacing the contact 70 toward the first signal line 110 is heated by supplying electric current to the heater 84 (cf. FIGS. 1A to 1C). The silicon oxide, which is the first component 80, and aluminum, which is the second component 82, are laminated in the movable part 50 from a side of the substrate 140 to form the first bimetal 10. Since the coefficient of thermal expansion of the second component 82 is higher than that of the first component 80 in the present embodiment, when the first bimetal 10 is heated, the first bimetal 10 generates stress which causes the movable part 50 to move toward the substrate 140 according to the difference of the coefficients of thermal expansion of the first component 80 and the second component 82. Then, the movable part 50 bends towards the substrate 140 while maintaining both the ends being connected to the supported sections 60 (FIG. 2B). Then, while the movable part 50 bends towards the substrate 140, the contact 70 approaches the substrate 140 and contacts with the first signal line 110 and the second signal line 120.

As described above, when the first bimetal 10 is heated by the heater 84, the movable part 50, which is originally bent upward in the direction away from the substrate 140, is deformed and begins to approach gradually toward the substrate 140 by the stress in the first bimetal 10. Then, when it begins to bend downward toward the substrate 140, the movable part 50 buckles towards the substrate 140. Therefore, after the movable part 50 bends downward toward the substrate 140 and the contact 70 contacts with the first signal line 110 and the second signal line 120, the movable part 50 maintains the downwardly bent position toward the substrate 140 (latch) even after the electric current fed to the heater 84 for heating the first bimetal 10 is cut. That is, the continuity between the first signal line 110 and the second signal line 120 is maintainable without supplying electric current to the heater 84.

Then, as shown in FIG. 2B, the second bimetal 20 for displacing the contact 70 in the direction away from the first signal line 110 and the second signal line 120 is heated by supplying electric current to the heater 84. By the movement opposite to the direction of the movement explained in reference to FIG. 2A, the movable part 50 buckles upward away from the substrate 140 as shown in FIG. 2C. Then, even after the electric current fed to the heater 84 for heating the second bimetal 20 is cut, the position of the movable part 50 is maintained in the upwardly bent position away from the substrate 140.

In the present embodiment, since the movable part 50 includes a bend in a predetermined direction, the movable part buckles in the direction opposite to the predetermined direction by heating the bimetals provided in the movable part 50. Since the position of the movable part 50 is maintained in the oppositely bent position against the predetermined position by buckling the movable part 50, the continuity/discontinuity between the first signal line 110 and the second signal line 120 is maintained by supplying the electric current to the heater 84 in the shortest time. That is, the electric power consumption of the switch 100 is substantially reducible.

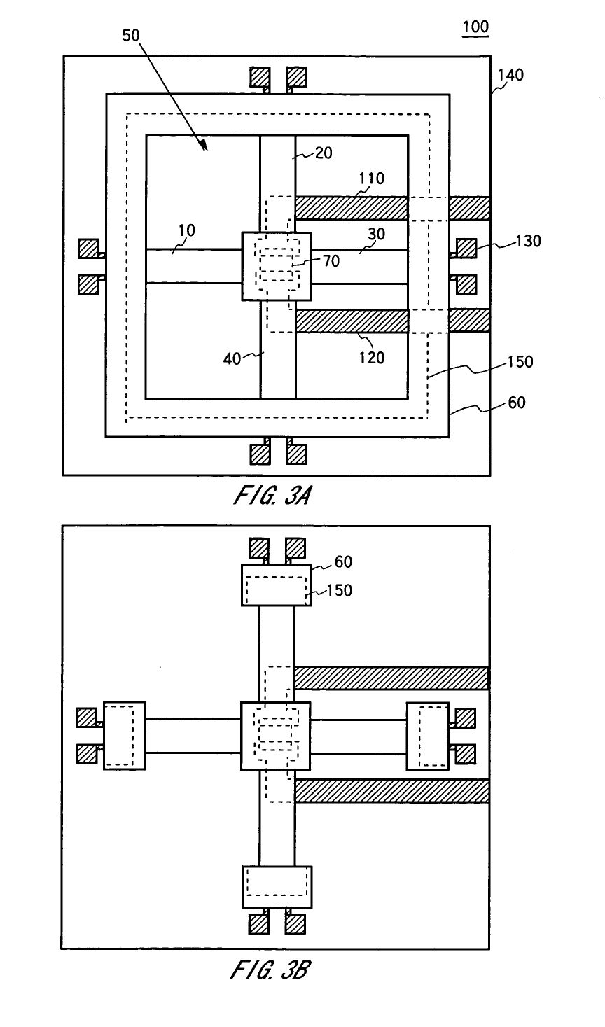

FIGS. 3A and 3B show a second embodiment of the switch 100. As shown in FIG. 3A, the movable part 50 includes a plurality of bimetals extending in different directions from the contact 70 for electrically connecting the first signal line 110 and the second signal line 120 or from the vicinity of the contact 70. In this case, it is preferable that the bimetals for displacing the contact 70 in a predetermined direction, and the bimetals for displacing the contact 70 in a direction opposite to the predetermined direction are symmetrically disposed about a line which passes through the contact 70. Alternatively, the bimetal is radially provided from the contact 70 or from the vicinity of the contact 70. In this case, it is preferable that the bimetals extending away from each other, i.e., in opposite directions, are the bimetals for displacing the contact 70 in a predetermined direction.

In the present embodiment, 50 includes: a first bimetal 10 extending from the contact 70 in a certain direction; a second bimetal 20 extending form the contact 70 in a direction substantially perpendicular to the certain direction; a third bimetal 30 extending from the contact 70 in a direction opposite to the certain direction; and a fourth bimetal 40 extending in a direction which is a direction substantially perpendicular to the certain direction and opposite to the direction in which the second bimetal 20 extends. Moreover, the switch 100 further includes: a supported section 60 surrounding the movable part 50; and a supporting section 150 provided on the substrate 140 corresponding to the supported section 60. Then, one end of each of the first bimetal 10, the second bimetal 20, the third bimetal 30, and the fourth bimetal 40 of the cross-shaped movable part 50 is connected to one another in the vicinity of the contact 70, and other ends are connected to the supported section 60. Then, the first bimetal 10 and the third bimetal 30 displace the contact 70 toward the substrate 140, and the second bimetal 20 and the fourth bimetal 40 displace the contact 70 away from the substrate 140.

Since the supporting section 150 and the supported section 60 surround the movable part 50, the switch 100 according to the present embodiment is hermetically sealed more easily. Moreover, the displacement of the contact 70 increases by collinearly providing the bimetals for displacing the contact 70 in a certain direction. Alternatively, as shown in FIG. 3B, a supported section 60 and a supporting section 150 are separately provided for each bimetal.

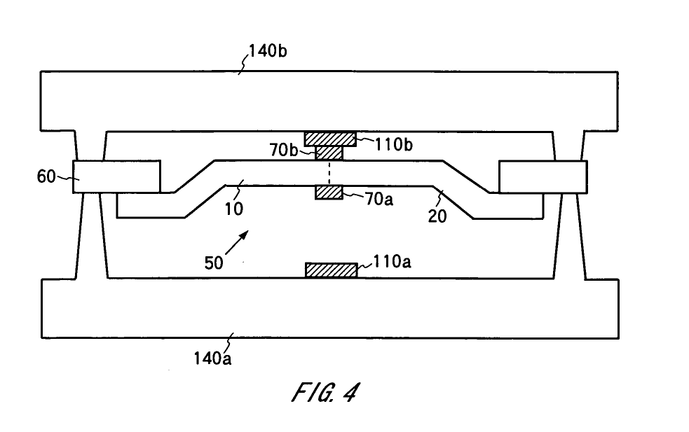

FIG. 4 shows a third embodiment of the switch 100. In FIG. 4, a component which bears the same reference numeral as the component depicted in FIGS. 1A to 3B has similar configuration and function to the component depicted in FIGS. 1A to 3B.

In the present embodiment, the switch 100 includes: substrates 140a and 140b provided in upper and lower sides of the movable part 50 and sandwiching the supported sections 60; a contact 70a provided on a surface of the movable part 50 confronting the substrate 140a; a contact 70b provided on a surface of the movable part 50 confronting the substrate 140b; and first signal lines 110a and 110b and second signal lines (not shown) provided on each of the substrates 140a and 140b, respectively.

Then, when the movable part 50 buckles toward the substrate 140a by heating the first bimetal 10, the contact 70a contacts with the first signal line 110a and the second signal line provided on the substrate 140a, and makes the electrical connection between the first signal line 110a and the second signal line. Moreover, when the movable part 50 buckles towards the substrate 140b by heating the second bimetal 20, the contact 70b contacts with the first signal line 110b and the second signal line provided on the substrate 140b, and makes the electrical connection between the first signal line 110b and the second signal line.

The switch 100 in the present embodiment selects the signal lines to be connected by providing a plurality of contacts on the movable part 50, and including signal lines corresponding to each contact. That is, it functions as a multiplexer.

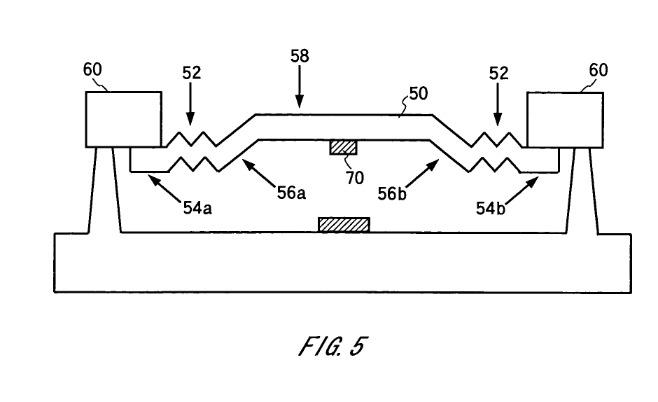

FIG. 5 shows a fourth embodiment of the switch 100. In FIG. 5, a component which bears the same reference numeral as the component depicted in FIGS. 1A to 4 has similar configuration and function to the component depicted in FIGS. 1A to 4.

In the present embodiment, the movable part 50 of the switch 100 includes elastic parts 52 between an area where the contact 70 on the movable part 50 is provided, and areas supported by the supported sections 60. It is preferable that the elastic parts 52 include elasticity in the longitudinal direction of the movable part 50, i.e., a direction substantially perpendicular to the direction in which the movable part 50 displaces the contact 70.

In the present embodiment, the movable part 50 includes: a first supported end 54a and a second supported end 54b provided at both ends of the movable part 50, and supported by the supported sections 60; a first inclined part 56a and a second inclined part 56b extending from the first supported end 54a and the second supported end 54b and inclined to the first supported end 54a and the second supported end 54b, respectively; and a central part 58 extending from the first inclined part 56a and the second inclined part 56b and provided between the first inclined part 56a and the second inclined part 56b. The elastic parts 52 are provided between the supported ends 54 and the inclined parts 56. Moreover, each of the elastic parts 52 includes a first section extending from the supported end 54 and inclined away from the supported end 54, and a second section inclined from the first section toward the supported end 54. Then, the first section and the second section form corrugated structure. Moreover, it is preferable that each of the elastic parts 52 includes a plurality of first sections and a plurality of second sections.

Alternatively, the sections in the elastic part 52 are of V-shaped or U-shaped. Moreover, in another embodiment, the elastic part 52 is made of elastic material expanding and contracting in the direction substantially perpendicular to the direction in which the movable part 50 displaces the contact 70. In this case, the elastic material maybe material expanding and contracting according to temperature.

According to the switch 100 in the present embodiment, the movable part 50 buckles more easily since the movable part 50 includes the elastic parts 52. As a result, the electric power consumption of the switch 100 is further reducible.

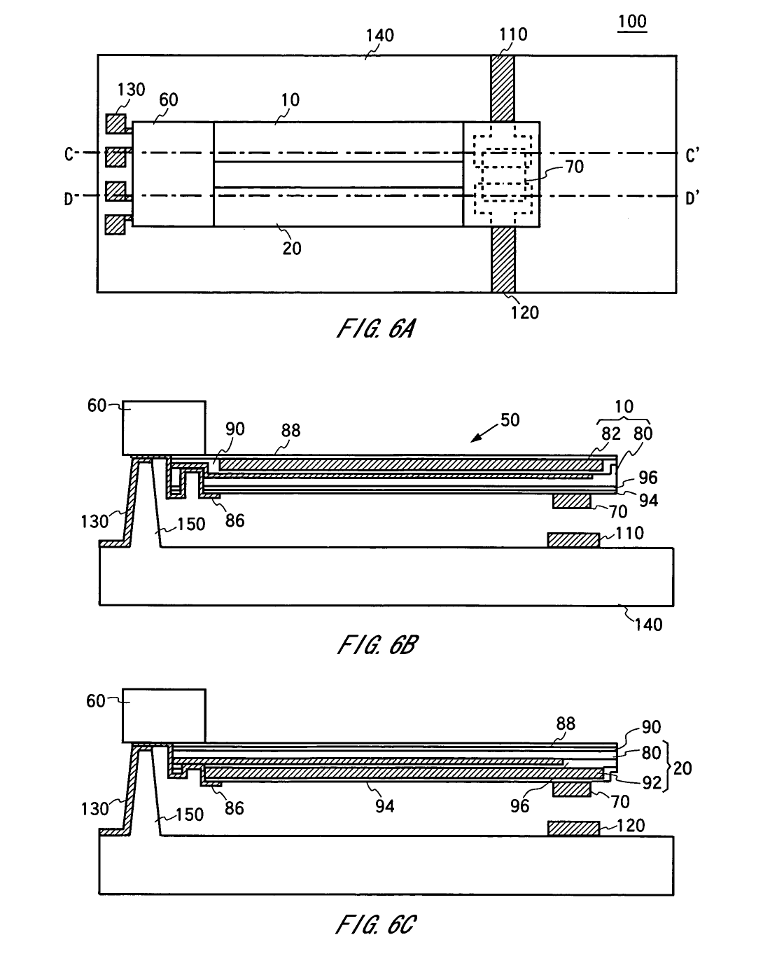

FIGS. 6A to 6C show a fifth embodiment of the switch 100. In FIGS. 6A to 6C, a component which bears the same reference numeral as the component depicted in FIGS. 1A to 5 has similar configuration and function to the component depicted in FIGS. 1A to 5. FIG. 6A is a top view of the switch 100, and FIGS. 6B and 6C are cross sectional views taken on lines C-C′ and D-D′ in FIG. 6A, respectively.

In the present embodiment, one end of the movable part 50 of the switch 100 is supported by the supported section 60. Moreover, the movable part 50 includes a first bimetal 10 for displacing the other end of the movable part 50 in a predetermined direction according to temperature, and a second bimetal 20 for displacing the other end of the movable part 50 in a direction opposite to the predetermined direction according to temperature. It is preferable that the first bimetal 10 and the second bimetal 20 are provided substantially parallel with a direction along the longitudinal direction of the movable part 50. In the present embodiment, the first bimetal 10 and the second bimetal 20 are arranged in parallel and provided substantially parallel with the longitudinal direction of the movable part 50. Moreover, the first bimetal 10 and the second bimetal 20 are connected to each other in the area in the vicinity of the contact 70 of the movable part 50, and are estranged from each other between the area in the vicinity of the contact 70 and the supported sections 60. In another example, the switch 100 includes heat insulating material between the first bimetal 10 and the second bimetal 20 for thermally insulating the first bimetal 10 and the second bimetal 20.

Moreover, it is preferable that the force of the bimetal 10 for moving the movable part 50 at a predetermined temperature is substantially the same as that of the bimetal 20 for moving the movable part 50 at the predetermined temperature.

According to the switch 100 in the present embodiment, even if the ambient temperature around the switch 100 changes, the position in the displacement direction of the contact 70 is maintainable to be substantially constant. As a result, the malfunction of the switch 100 can be prevented.

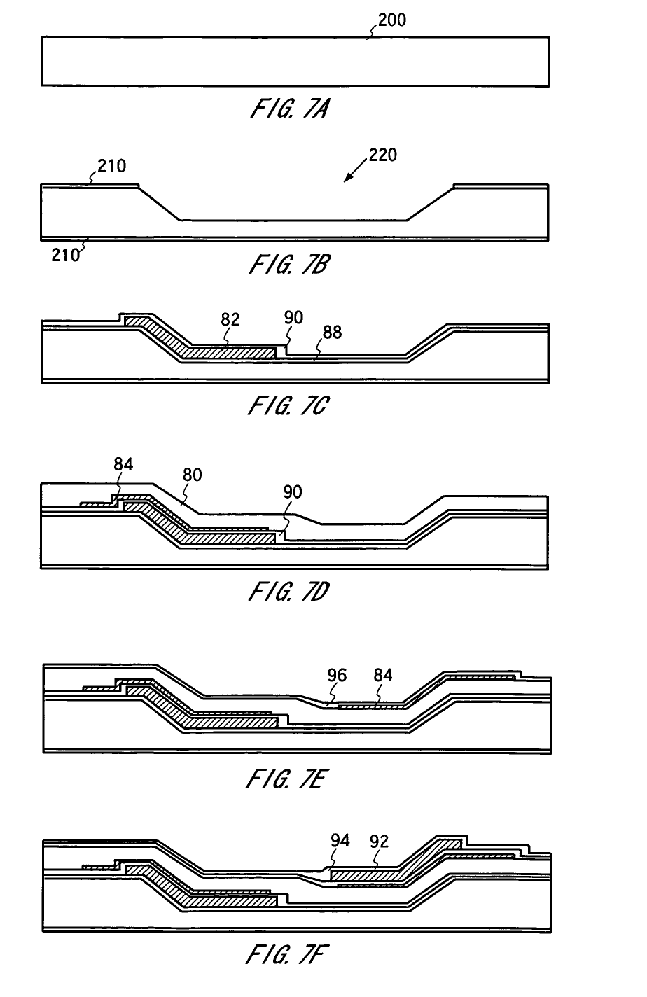

FIGS. 7A to 7F show process of manufacturing method of the switch according to an embodiment of the present invention. Hereinafter, the manufacturing method of the switch will be exemplary explained in reference to the A-A′ cross sectional view depicted in FIG. 1A. First, as shown in FIG. 7A, a silicon substrate 200, which is an example of a movable part formation substrate for forming the movable part, is prepared.

Then, as shown in FIG. 7B, a slot 220 will be formed in the predetermined area of the silicon substrate 200. First, silicon oxide film 210 is formed on front face and rear face of the silicon substrate 200 by CVD. Then, a part of the silicon oxide film 210 formed on the front face of the silicon substrate 200 is removed so that it has a predetermined pattern. Then, the slot 220 for forming the movable part with bend is formed by etching the silicon substrate 200 by anisotropy wet etching using potassium hydroxide (KOH) and using the remaining silicon oxide film 210 as a mask.

Then, as shown in FIG. 7C, the protective film 88, the second component 82, and the insulating film 90 will be formed. First, the silicon oxide film 210 remained on the front face of the silicon substrate 200 is removed, and the protective film 88 is formed on the surface. It is preferable that the protective film 88 is made of insulating material such as silicon oxide, silicon, silicon nitride, and aluminum oxide. In the present embodiment, the protective film 88 is silicon oxide film, and is formed by CVD.

Subsequently, the second component 82 constituting a part of the first bimetal 10 (cf. FIG. 1) will be formed on the protective film 88. It is preferable that the second component 82 is made of material having high coefficient of thermal expansion, such as aluminum, nickel, and nickel-iron alloy. In the present embodiment, the second component 82 is aluminum and is formed in a predetermined area by lift-off technology using resist film including a predetermined pattern and sputtering. In another embodiment, the second component 82 is formed by etching the deposited material, such as aluminum, using the resist pattern after the aluminum is deposited by sputtering or the like.

After forming the second component 82, the insulating film 90 for insulating the second component 82 and the heater 84 (cf. FIG. 1) will be formed on the second component 82 and the protective film 88. The insulating film 90 is made of insulating material such as a silicon oxide, silicon, silicon nitride, and aluminum oxide. In the present embodiment, the insulating film 90 is silicon oxide and is formed by CVD. Alternatively, when the second component 82 is made of insulating material, the step of forming the insulating film 90 is omitted.

Then, as shown in FIG. 7D, the heater 84 for heating the first bimetal 10 and the first component 80 will be formed. First, in the area where the first bimetal 10 is to be formed, the heater 84 is formed on the insulating film 90. It is preferable that the heater 84 is made of material of which the coefficient of thermal expansion is higher than that of the material of the first component 80, and is lower than that of the material of the second component 82. In the present embodiment, the heater 84 is formed of metallic resistors such as nickel-chromium alloy and chromium-platinum metallic multilayer film using lift-off technology.

Subsequently, in the area where the first bimetal 10 is to be formed, the first component 80 will be formed on the heater 84 and the insulating film 90. The first component 80 is made of material of which the coefficient of thermal expansion is lower than the material of the second component 82. Specifically, it is preferable that it is made of the insulating material such as silicon oxide, silicon, silicon nitride, and aluminum oxide. In the present embodiment, the first component 80 is silicon oxide and is formed by CVD.

Then, as shown in FIG. 7E, the heater 84 for heating the second bimetal 20 and the insulating film 96 for insulating the heater 84 and the third component 92 constituting a part of the second bimetal 20 will be formed. First, in an area where the second bimetal 20 is to be formed, the heater 84 is formed on the first component 80. It is preferable that the heater 84 is made of material of which the coefficient of thermal expansion is higher than the material of the first component 80, and is lower than the material of the third component 92. In the present embodiment, the heater 84 is formed of metallic resistors such as nickel-chromium alloy and chromium-platinum metallic multilayer film using lift-off technology.

Subsequently, the insulating film 96 for insulating the third component 92 and the heater 84 will be formed on the first component 80 and the heater 84. The insulating film 90 is made of insulating material such as silicon oxide, silicon, silicon nitride, and aluminum oxide. In the present embodiment, the insulating film 96 is silicon oxide and is formed by CVD. Alternatively, when the third component 92 is made of insulating material, the step of forming the insulating film 96 is omitted.

Then, as shown in FIG. 7F, the third component 92 constituting a part of the second bimetal 20 and the protective film 94 will be formed. First, the third component 92 is formed on the insulating film 96. It is preferable that the third component 92 is made of material with high coefficient of thermal expansion, such as aluminum, nickel, and nickel-iron alloy. In the present embodiment, the third component 92 is aluminum and is formed in a predetermined area by lift-off technology using the resist film including a predetermined pattern and sputtering. In another embodiment, the third component 92 is formed by etching the deposited material, such as aluminum, using the resist pattern after the aluminum is deposited by sputtering or the like.

It is preferable that the third component 92 constituting a part of the second bimetal 20 is made of the same material as the second component 82 constituting a part of the first bimetal 10, i.e., the material having substantially the same coefficient of thermal expansion as the second component 82. It is also preferable the third component 92 is formed so that the area and the thickness of the third component 92 are substantially the same as those of the second component 82. Stresses in the first bimetal 10 and the second bimetal 20 is substantially equalized by forming the second component 82 and the third component 92 by the same material and by making their areas and thicknesses substantially equal to each other.

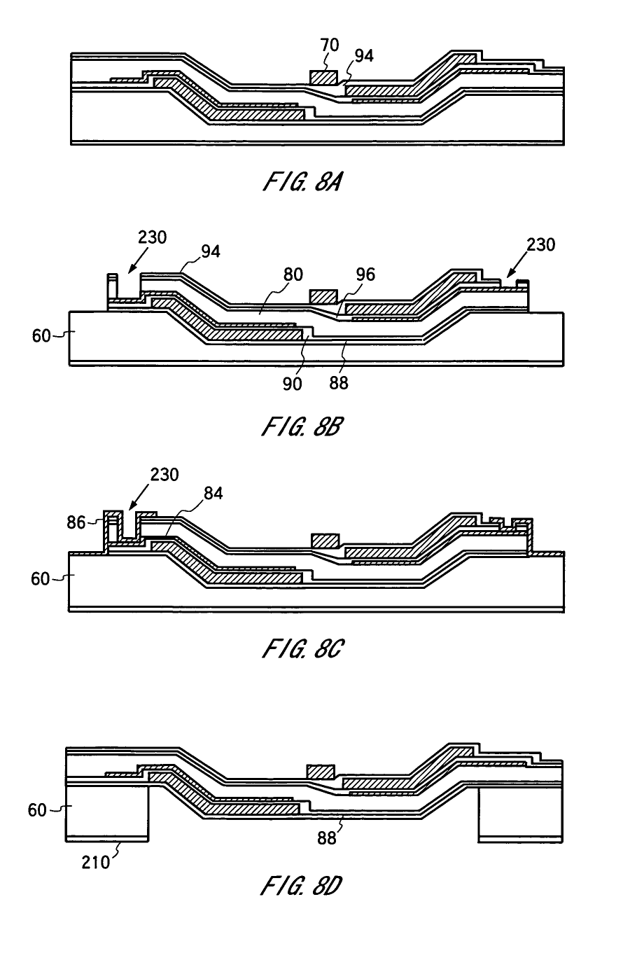

FIGS. 8A to 8D show process of the manufacturing method of the switch 100.

As shown in FIG. 8A, the contact 70 is formed on the protective film 94. It is preferable that the contact 70 is made of metallic material having high conductivity, such as platinum and gold, for example. Alternatively, the contact 70 is metallic multilayer film made of a plurality of metallic material. In the present embodiment, the contact 70 is chromium-platinum multilayer film and is formed by lift-off technology. Moreover, the contact 70 may be formed by plating or bumping.

Then, as shown in FIG. 8B, contact holes 230 for the heaters 84 are formed by etching the protective films 88 and 94, the insulating films 90 and 96, and the first component 80. The contact holes 230 may be formed by wet etching or dry etching. In this case, it is preferable to etch a part of the protective films 88 and 94, the insulating films 90 and 96, and the first component 80 provided on the supported sections 60. In the present embodiment, the protective films 88 and 94, the insulating films 90 and 96, and the first component 80 on the supported section 60, which exist in areas to be in contact with the supporting sections 150 on the substrate 140, are removed.

Then, as shown in FIG. 8C, the heater lead wires 86 will be formed. It is preferable that the heater lead wires 86 are formed from the heater 84 in the bottom of the contact holes 230 to the front face of the supported sections 60. In the present embodiment, the heater lead wires 86 are made of chromium-platinum multilayer film using lift-off technology.

Then, as shown in FIG. 8D, the supported sections 60 will be formed by etching the silicon substrate 200. First, the silicon oxide film 210 provided on the rear face of the silicon substrate 200 is etched by wet etching excluding the area where the supported sections 60 are to be formed. Then, the supported sections 60 are formed by etching the silicon substrate 200 by dry etching using the remaining silicon oxide film 210 as mask. In this case, the etching is performed using the protective film 88 as a stopper.

Moreover, in reference to FIGS. 1A to 1C, it is preferable to remove the protective films 88 and 94, the insulating films 90 and 96, and the first component 80, which exist in an area between the first bimetal 10 and the fourth bimetal 40, and in an area between the second bimetal 20 and the third bimetal 30, so that the adjoining bimetal is thermally estranged. In another example, a step of forming heat insulating material in the areas is further included.

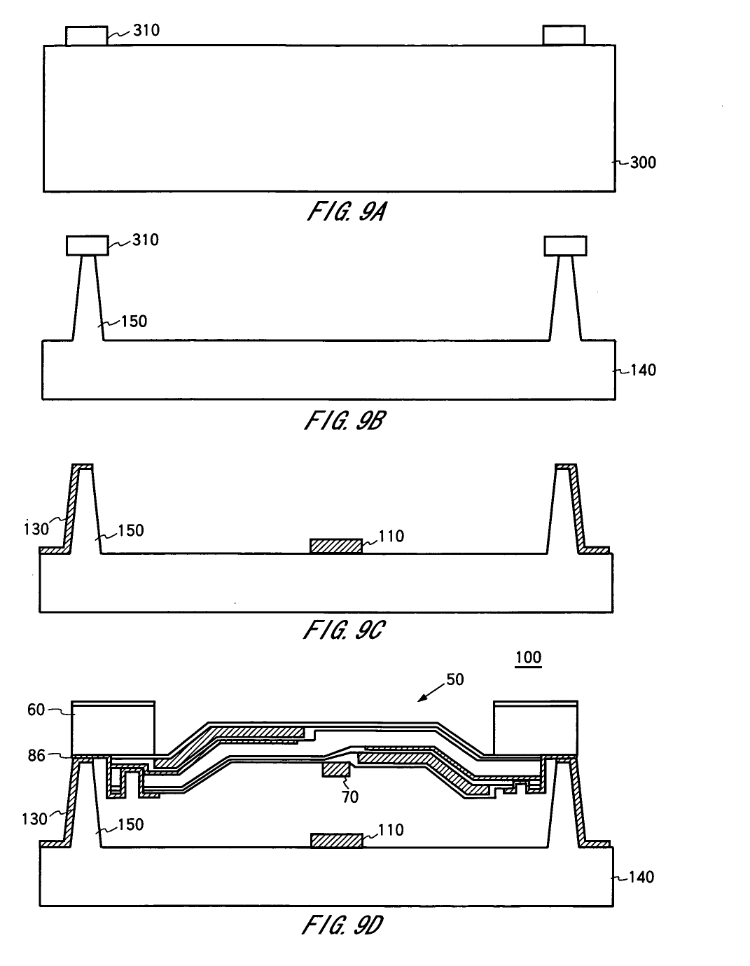

FIGS. 9A to 9D show process of the manufacturing method of the switch 100.

As shown in FIG. 9A, the glass substrate 300, which is an example of the substrate for forming the substrate 140, is prepared. Then, masks 310 for forming the supporting sections 150 by etching are formed on the glass substrate 300. For example, the masks 310 are resist patterns. Alternatively, the masks 310 are made of inorganic material, such as silicon nitride.

Then, as shown in FIG. 9B, the glass substrate 300 is etched using the masks 310 as masks. In the present embodiment, the substrate 140 having the tapered supporting sections 150 is obtained by the wet etching of the glass substrate 300 using hydrofluoric-acid solution.

Then, as shown in FIG. 9C, the heater electrodes 130, the first signal line 110, and the second signal line 120 (cf. FIGS. 1A to 1C) are formed on the substrate 140. It is preferable that the heater electrodes 130, the first signal line 110, and the second signal line 120 are made of metallic material having high conductivity, such as platinum and gold, for example. Alternatively, to improve the adhesion of the first signal line 110, the second signal line 120 and the heater electrodes 130 to the substrate 140, titanium-chromium multilayer film, titanium-platinum multilayer film or the like is provided as an adhesion layer between the first signal line 110, the second signal lines 120 and the heater electrodes 130, and the substrate 140. In the present embodiment, the heater electrodes 130, the first signal line 110, and the second signal line 120 are made of chromium-platinum multilayer film using lift-off technology.

It is preferable that the heater electrodes 130 are formed from the surfaces where the supported sections 60 contact with the supporting sections 150 and over the substrate 140. Alternatively, a step of forming the heater electrodes 130, and material and thickness of the heater electrodes 130 are different from those of the first signal line 110 and the second signal line 120.

FIG. 9D shows a step of fixing the movable part 50 to the substrate 140 by connecting the supported sections 60 and the supporting sections 150. First, positions of the supported sections 60 and the supporting sections 150, and positions of the contact 70 and the first/second signal lines 100/120 are aligned. Then, the areas where the heater lead wires 86 are provided on the supported sections 60, and the areas where the heater electrodes 130 are provided on the top of the supporting sections 150, are contacted. Then, the switch 100 is obtained by thermocompression bonding of the supported sections 60 and the supporting sections 150 by heating at least the areas where the heater lead wires 86 contact with the heater electrodes 130.

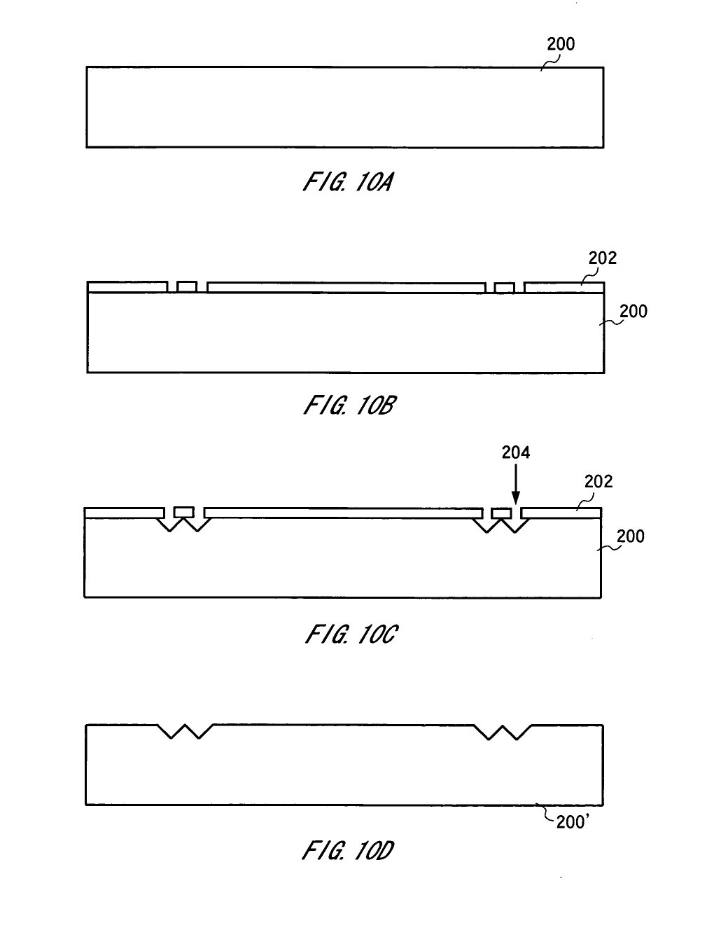

FIGS. 10A to 10D show another example of the steps of providing the movable part formation substrate, which has been explained in FIG. 7A. In this example, the movable part formation substrate is a substrate for forming the movable part 50 including the elastic parts 52 explained in reference to FIG. 5. First, as shown in FIG. 10A, the silicon substrate 200 is prepared.

Then, as shown in FIG. 10B, a mask 202 for forming slots in areas where the elastic parts 52 in the silicon substrate 200 are to be formed is formed. Moreover, it is preferable that the mask 202 is made of material of which the etch rate in the etchant for etching the silicon substrate 200 is low enough in the step of etching the silicon substrate 200. In the present embodiment, the mask 202 is silicon oxide film and includes openings at the areas where the slots are to be formed.

Then, as shown in FIG. 10C, the slots 204 are formed on the silicon substrate 200. The slots 204 are formed by etching the silicon substrate 200 by anisotropy wet etching using the mask 202 as a mask. Then, as shown in FIG. 10D, a silicon substrate 200′, which is the movable part formation substrate including the slots 204 for forming the elastic parts 52, is obtained by removing the mask 202. Then, the switch 100 will be formed by similar steps to the steps explained in reference to FIGS. 7B-9C.

As it is obvious from the foregoing explanation, according to the present invention, there is provided the switch with low power consumption.

Although the present invention has been described by way of exemplary embodiment, the scope of the present invention is not limited to the foregoing embodiment. Various modifications in the foregoing embodiment may be made when the present invention defined in the appended claims is enforced. It is obvious from the definition of the appended claims that embodiments with such modifications also belong to the scope of the present invention.

What is claimed is:

1. A switch comprising a movable part supported at both ends, and a first contact provided between both the ends of said movable part, wherein
said movable part comprises:
a first bimetal for displacing said contact in a predetermined direction according to temperature; and
a second bimetal for displacing said contact in a direction opposite to the predetermined direction according to temperature.

2. The switch as claimed in claim 1, wherein said movable part comprises a bend in the predetermined direction or the direction opposite to the predetermined direction.

3. The switch as claimed in claim 1, wherein
said first bimetal comprises:
a first component having a first coefficient of thermal expansion; and
a second component deposited on said first component and having a coefficient of thermal expansion lower than the first coefficient of thermal expansion, and
said second bimetal comprises:
a third component having a second coefficient of thermal expansion; and
a fourth component deposited on said third component and having a coefficient of thermal expansion higher than the second coefficient of thermal expansion.

4. The switch as claimed in claim 3, wherein said first component and said fourth component are made of the same material, and said second component and said third component are made of the same material.

5. The switch as claimed in claim 3, further comprising heaters for heating said first bimetal and said second bimetal, respectively, wherein
said movable part bends in the predetermined direction when said first bimetal is heated, and
said movable part bends in the direction opposite to the predetermined direction when said second bimetal is heated.

6. The switch as claimed in claim 1, wherein both the ends of said movable part are secured.

7. The switch as claimed in claim 1, wherein
said movable part further comprises:
a third bimetal for displacing said contact in the predetermined direction according to temperature; and
a fourth bimetal for displacing said contact in the direction opposite to the predetermined direction according to temperature.

8. The switch as claimed in claim 7, wherein
said first bimetal, said second bimetal, said third bimetal and said fourth bimetal extend in different directions from a contact position at which said contact is provided.

9. The switch as claimed in claim 8, wherein
said first bimetal extends in a direction opposite to a direction in which said third bimetal extends,
said second bimetal extends in a direction substantially perpendicular to the directions in which said first bimetal and said third bimetal extend, and
said fourth bimetal extends in a direction opposite to the direction in which said second bimetal extends.

10. The switch as claimed in claim 7, further comprising:
a first supporting section for supporting one end of said movable part; and
a second supporting section for supporting the other end of said movable part, wherein
one end of said first bimetal is supported by said first supporting section,
one end of said second bimetal is supported by said second supporting section, and another end of said second bimetal extends from said first bimetal,
one end of said third bimetal is supported by said second supporting section and provided substantially parallel with said second bimetal, and
one end of said fourth bimetal is supported by said first supporting section and another end of said fourth bimetal extends from said third bimetal.

11. The switch as claimed in claim 10, wherein
said first bimetal and said third bimetal, and said second bimetal and said fourth bimetal, are estranged from each other.

12. The switch as claimed in claim 7, wherein
each of said first bimetal and said third bimetal comprises:
a first component having a first coefficient of thermal expansion; and
a second component deposited on said first component and having a coefficient of thermal expansion lower than the first coefficient of thermal expansion, and
each of said second bimetal and said fourth bimetal comprises:
a third component having a second coefficient of thermal expansion; and
a fourth component deposited under said third component and having a coefficient of thermal expansion higher than the second coefficient of thermal expansion.

13. The switch as claimed in claim 7, wherein said movable part includes a bend in the predetermined direction or in the direction opposite to the predetermined direction.

14. The switch as claimed in claim 13, further comprising heaters for heating said first bimetal, said second bimetal, said third bimetal and said fourth bimetal, respectively, wherein
said movable part bends in the predetermined direction when said first bimetal and said third bimetal are heated, and
said movable part bends in the direction opposite to the predetermined direction when said second bimetal and said fourth bimetal are heated.

15. The switch as claimed in claim 1, further comprising a first substrate including a first signal line, a second signal line, and a first supporting section for supporting both the ends of said movable part, wherein
said first contact electrically connects said first signal line and said second signal line by contacting with said first signal line and said second signal line.

16. The switch as claimed in claim 15, further comprising:
a second substrate including a third signal line, a fourth signal line, and a second supporting section for supporting both the ends of said movable part; and
a second contact provided on a surface opposite to the surface on which said contact is provided in said movable part, wherein
said second contact electrically connects said third signal line and said fourth signal line by contacting with said third signal line and said fourth signal line.

17. The switch as claimed in claim 1, wherein said movable part comprises an elastic part provided between one end of said movable part and said contact, said elastic part having elasticity in a longitudinal direction of said movable part.

18. The switch as claimed in claim 17, wherein said elastic part has corrugated structure.

19. A manufacturing method of a switch comprising a movable part supported at both ends, and a first contact provided on the movable part, the method comprising steps of:
preparing a substrate;
forming a first component in a first area of the substrate, the first component having a first coefficient of thermal expansion in;
forming a second component in a second area of the substrate, the second area including the first area and the second component having a second coefficient of thermal expansion lower than the first coefficient of thermal expansion; and
forming a third component in a third area of the substrate, the third area being included in the second area and does not overlap with the first area, and the third component having a coefficient of thermal expansion higher than the second coefficient of thermal expansion.

20. The manufacturing method of a switch as claimed in claim 19, wherein said step of forming the first component is similar to said step of forming the third component.

21. The manufacturing method of a switch as claimed in claim 19, further comprising a step of removing at least a part of the second component formed between the first area and the third area.

22. An actuator, comprising:
a movable part supported at both ends and including a bend in a predetermined direction; and
a drive section for bending said movable part in a direction opposite to the predetermined direction.

23. An actuator comprising a movable part supported at at least one end, wherein
said movable part comprises:
a first bimetal for displacing another end of said movable part in a predetermined direction according to temperature; and
a second bimetal for displacing the other end of said movable part in a direction opposite to the predetermined direction according to temperature.

24. The actuator as claimed in claim 23, wherein said first bimetal and said second bimetal are provided in a direction substantially parallel with a longitudinal direction of said movable part.
